(19) United States
(12) Patent Application Publication
(10) Pub. No.: US 2024/0241298 A1
(43) Pub. Date: Jul. 18, 2024

(54) INFRARED CUT-OFF FILTER ARRANGEMENT FOR AN OPTICAL SENSING ARRANGEMENT FOR A CAMERA OR A CAMERA MODULE FOR AN AUTOMOTIVE APPLICATION AND/OR AN ELECTRONIC DEVICE AND METHOD FOR PRODUCING AN INFRARED CUT-OFF FILTER ARRANGEMENT

(71) Applicant: SCHOTT Glass Technologies (Suzhou) Co. Ltd., Suzhou (CN)

(72) Inventors: Yigang Li, Suzhou (CN); Yongjian Wang, Shanghai (CN); Feng He, Suzhou (CN); Hongyun Wang, Suzhou (CN); Ralf Biertümpfel, Mainz (DE)

(73) Assignee: SCHOTT Glass Technologies (Suzhou) Co. Ltd., Suzhou (CN)

(21) Appl. No.: 18/619,614

(22) Filed: Mar. 28, 2024

Related U.S. Application Data
(63) Continuation of application No. PCT/CN2021/122200, filed on Sep. 30, 2021.

(51) Int. Cl. G02B 5/20; G03B 11/00

(52) U.S. Cl. CPC G02B 5/208; G03B 11/00

(57) ABSTRACT

An optical sensing arrangement for a camera or a camera module for at least one of an automotive application and an electronic device, includes: an optical lens or a lens system; a sensor; and an infrared cut-off filter arrangement, which has a total thickness of less than 0.8 mm and which includes: at least one infrared cut-off filter element, which includes a first major surface and which includes or consists of a glass which includes copper oxide; and a first cover element, which is arranged in front of the first major surface of the at least one infrared cut-off filter element and which includes an ultra-thin glass.

### CROSS REFERENCE TO RELATED APPLICATIONS

This is a continuation of PCT application no. PCT/CN2021/122200, entitled “INFRARED CUT-OFF FILTER ARRANGEMENT FOR AN OPTICAL SENSING ARRANGEMENT FOR A CAMERA OR A CAMERA MODULE FOR AN AUTOMOTIVE APPLICATION AND/OR AN ELECTRONIC DEVICE AND METHOD FOR PRODUCING AN INFRARED CUT-OFF FILTER ARRANGEMENT”, filed Sep. 30, 2021, which is incorporated herein by reference.

### BACKGROUND OF THE INVENTION

### 1. Field of the Invention

The present invention relates to infrared cut-off filter arrangements.

### 2. Description of the Related Art

Auto-focusing modules have widely been used in smartphone cameras or other handheld electronic devices, such as for example tablet computers, notebooks, external camera modules or handheld cameras. In these autofocus modules, the lens is generally movable by and often arranged in a Voice Coil Motor or Actuator (VCM/VCA). When the power is switched off, the lens is typically still in a movable position, such that the lens could be moved inside the VCM or VCA, for example when the electronic device is prone to an abrupt motion or eventually dropped down.

Often the lens might impact on the filter, especially on the infrared cut-off filter, if the autofocus VCM motor suddenly draws back the lens in a direction towards the sensor, for example in case of externally applied shocks, vibrations, or also due to an empty battery of the electronic device including the autofocus module.

Both impact situations may lead to a broken infrared cut-off filter. Furthermore, since the trend is towards an increased resolution, larger sensors are used in high-end smartphones. Sensors typically exhibit a high sensitivity to infrared (IR) light, that may cause distortions in the recorded image due to aberrations in color and brightness. Moreover, in combination with larger sensors, larger infrared cut-off filters are also needed to eliminate or reduce distortions caused by IR light in the displayed image. However, in general the total thickness of the camera modules should become smaller or at least need to have been fixed at specific dimensional values for optical design reason, such as for instance an optional thickness of 0.21 mm. It has been shown that larger Infrared cut-off filters are easier to break in real life and also in typical set-drop tests.

CN 212160136 U describes a complex high-strength blue glass filter with bending resistance, including a blue glass substrate and up to twenty layers of glue and filters such as an interference filter layer, antireflection (AR) and an antifingerprint layer at both sides of the blue glass filter. The strength of this design may result from glass cement, which is arranged between the optical filter layers and the blue glass substrate.

In WO16061738 A1 an optical arrangement for a camera module is disclosed. The optical arrangement includes an infrared absorbing infrared cut-off filter and a transparent cover element, wherein the transparent cover element is made of generally brittle material, such as sapphire to obtain a protective IR filter with sufficient mechanical strength. Since essentially only the thickness of the infrared cut-off filter matches the above-mentioned specific value for an infrared cut-off filter, the total thickness of the optical arrangement including the sapphire glass is much larger.

DE 10 2014 106 698 A1 relates to an optical filter device including a phosphate filter glass with light-absorbing components. To avoid deleterious influences of moisture, a pane of a glass is disclosed cemented to the surface of the filter glass by way of an optical putty, wherein the coefficient of thermal expansion of the pane of the thin glass is lower than the thermal coefficient of expansion of the disk-shaped filter glass including phosphate or fluorophosphate glass. However, due to the dimensions of the optical filter device, it is difficult to use those optical filter devices for smartphone cameras or other handheld electronic devices.

What is needed in the art is an infrared cut-off filter for cameras or camera modules for an automotive application and/or for electronic devices, especially for handheld electronic devices, with an increased mechanical stability and with a low thickness that is apt to match widely used or at least common standard values, such as for example a thickness of 0.21 mm.

### SUMMARY OF THE INVENTION

The invention relates to an infrared cut-off filter arrangement for an optical sensing arrangement for a camera or a camera module for an automotive application and/or an electronic device, an optical sensing arrangement for a camera or camera module for an electronic device including an infrared cut-off filter arrangement, especially for a hand held electronic device, as well as to a method for producing an infrared cut-off filter arrangement.

Accordingly, an optical sensing arrangement for a camera or a camera module for an automotive application and/or an electronic device, especially a hand held electronic device, includes:
an optical lens or lens system;
a sensor, in particular an optical image sensor for sensing optical signals within a specific spectrum of light, optionally the spectrum of visible light;
an infrared cut-off filter arrangement which includes:
   at least one infrared cut-off filter element;
   and
   at least a first cover element, which is arranged in front of a first major surface of the infrared cut-off filter element;
   optionally such that optionally the first cover element and the infrared cut-off filter element are arranged along an incident optical beam path of light propagating towards the sensor.

The infrared cut-off filter element includes or consists of glass which contains copper oxide, and the cover element includes ultra-thin glass, and the infrared cut-off filter arrangement has a total thickness of less than 0.8 mm, optionally less than 0.5 mm.

In an optional embodiment, especially as used in a hand held device as for instance in a smartphone, the total thickness of the infrared cut-off filter arrangement may be about 0.21 mm. In this embodiment the infrared cut-off filter may have a thickness of about 0.11 mm, an optionally optically clear adhesive which might be arranged between the infrared cut-off filter element and the cover element and may have a thickness of about 0.03. In this embodiment, the ultra-thin glass may have a thickness of about 0.07 mm.

For an automotive application, the total thickness may be about 0.3-0.5 mm.

The disclosed improved infrared cut-off filter design may be directly used to replace an infrared cut-off filter in common smartphone cameras or other handheld electronic devices, especially having an 0.21 mm thick IRCF, or also in devices with a large and/or high resolution sensor.

Significantly, the improved infrared cut-off filter is easy to produce, in particular with a reduced number of procedural steps in view of the above-cited prior art designs.

In an optional embodiment, the infrared cut-off filter element may include CuO-containing glass and the cover element includes ultra-thin glass. Accordingly, NIR cut-off filters according to the present invention are optionally glasses doped with copper ions. In compositions mentioned here, the Cu content is given as CuO content and respective glasses are mentioned as CuO containing or copper oxide containing glasses. In general, an infrared cut-off filter element is meant to be a near infrared absorbing filter element.

The term ultra-thin glass (UTG) is meant to describe a glass, which generally exhibits a thickness between optionally 50 μm and 100 μm. Significantly, the thickness of the ultra-thin glass of the cover element is less than the thickness of the infrared cut-off filter element, in particular to limit the total thickness of the infrared cut-off filter arrangement to a desired value within a commonly used range for an infrared cut-off filter.

In a further embodiment, especially an embodiment for an automotive application, the infrared cut-off filter arrangement might have a total thickness of less than 0.8 mm, optionally less than 0.5 mm.

If the camera or the camera module provides an autofocus functionality, the optical lens or lens system may be movable by an actuator parallel to the optical symmetry axis of the optical lens or lens system. With an autofocus functionality, the camera or a camera module may be operated automatically or under remote control, which is especially useful in automotive applications.

In order to provide a support for the autofocus functionality or to provide the autofocus functionality, the image sensor might also be or might alternatively be movable by an actuator parallel to the optical symmetry axis of the optical lens or lens system, especially in a not tilted or laterally shifted position of the of the optical lens or lens system. For the sake of clarity, a motion caused by an actuator parallel to the optical symmetry axis also is deemed to be a motion in the direction of the optical symmetry axis.

In one embodiment, the optical sensing arrangement includes a housing, especially a dedicated housing, optionally to form a camera or a camera module for an automotive application and/or an electronic device, especially a hand held electronic device itself.

An aspect of the present invention is directed to an infrared cut-off filter arrangement for an optical sensing arrangement for a camera or a camera module, in particular according to the aforementioned disclosure for an automotive application and/or an electronic device, especially a hand held electronic device, wherein the infrared cut-off filter arrangement includes:
at least one infrared cut-off filter element, which includes or consists of CuO-containing glass; and
at least a first cover element, which is arranged in front of a first major surface of the infrared cut-off filter element, optionally such that the first cover element and the infrared cut-off filter element are optionally arranged along an incident optical beam path of light propagating towards an optical image sensor,
wherein the cover element includes ultra-thin glass, and the infrared cut-off filter arrangement has a total thickness of less than 0.8 mm, optionally less than 0.5 mm.

In the context of the disclosure, the above mentioned incident optical beam path OP propagating from the lens 20 towards the optical image sensor is chosen for clarity reasons to propagate along the optical axis OA or optical symmetry axis of the lens or lens system and, accordingly in some embodiments along the optical axis or optical symmetry axis of the infrared cut-off filter arrangement.

According to the disclosure of the present invention, the first major surface or the second major surface of the infrared cut-off filter element is as a major surface of a sheet-shaped or sheet-like glass element, wherein the two major surfaces are essentially parallel to each other having a size that is more than 5 times larger than the size of the remaining surfaces of the sheet-shaped or sheet-like glass element, optionally at least 10 or 15 times larger. In other words, the infrared cut-off filter element may be formed as a CuO-containing glass sheet-shaped glass element, in particular with a front surface, which may be understood as the first major surface and an opposing rear surface that may be understood as the second major surface of the infrared cut-off filter element.

Optionally, the first major surface may be directed to the first cover element, and in particular, to the lens or lens system when the infrared cut-off filter is mounted in a camera module. The second major surface may then be directed for example to the optical image sensor.

The cover element, which is arranged on the infrared cut-off filter element, especially arranged on the first major surface of the infrared cut-off filter element improves or adds mechanical strength to the infrared cut-off filter arrangement, such that it exhibits an improved protection against mechanical impacts. This strength may be characterized based on a standardized ring-on-ring test, especially according or similar to ASTM C1499, or a ball drop test, as for instance a ball drop test according to ASTM F 3007.

According to a further aspect of the present invention, the infrared cut-off filter arrangement includes a second cover element, which is arranged in the optical beam path, optionally opposing the second major surface of the infrared cut-off filter element. Thus, the second cover element may face the second major surface of the infrared cut-off filter element.

A second cover element provides additional mechanical stability to the infrared cut-off filter element. Optionally, the infrared cut-off filter arrangement may include a sandwich shaped or sandwich like structure, in which the infrared cut-off filter element is positioned between the first and the second cover element. While the first major surface of the infrared cut-off filter element is directed to the first cover element, the second major surface is optionally directed to the second cover element, in particular such that an improved mechanical stability is provided on both surfaces of the infrared cut-off filter element. According to this embodiment, the infrared cut-off filter arrangement may be applied to or be built in the camera module or other electronic devices independently of its orientation.

In an optional embodiment, the thickness of the ultra-thin glass of the first and/or second cover element is smaller than 0.3 mm, and/or greater than 0.05 mm, optionally greater than 0.07 mm.

In a further embodiment, the thickness of the ultra-thin glass of the first and/or second cover element may be less than 0.1 mm, optionally less than 0.07 mm, optionally less than 0.05 mm and/or greater than 0.01 mm, optionally greater than 0.02 mm, optionally greater than 0.03 mm. The thickness of the first cover element may be greater or smaller than the thickness of the second cover element. Since the thickness of the ultra-thin glass, in particular of the first and/or second cover element, determines the overall suitability or rather applicability of the infrared cut-off filter arrangement, the cover elements should have a very small thickness.

To provide improved mechanical stability, the first and/or second cover element optionally has a sheet-like shape or is sheet-shaped and/or includes or consists of at least one of the following glasses: Alumosilicate glass, lithium alumosilicate glass, sodalime glass and/or borosilicate glass. The ultrathin glass is optionally transparent and/or does not necessarily provide a spectral absorption similar or identical to the CuO-containing glass.

Consequently, the ultrathin glass of the cover element might essentially be free of absorption and losslessly transmits the light, intended to be detected with the optical image sensor.

However, in some embodiments, the transmission of the first and/or second cover element may be above 80%, optionally above 85% and optionally above 90% for electromagnetic radiation at wavelengths at least in the visible range, i.e. in particular between 380 nm und 750 nm.

All proportions given in this specification are in % by weight on an oxide basis unless indicated otherwise.

The ultra-thin glass may include:
between 10 wt % and 20 wt % of Al₂O₃,
between 1 wt % and 10 wt % of K₂O,
between 10 wt % and 20 wt % of Na₂O,
between 60 wt % and 70 wt % SiO₂
between 1 wt % and 10 wt % of MgO,
below 1 wt % of SnO,
below 1 wt % of AlF₃,
between 1 wt % and 10 wt % of ZrO₂, and/or,
   in an alternative embodiment, the ultra-thin glass may include:
between 1 wt % and 10 wt % of Al₂O₃,
between 1 wt % and 10 wt % of K₂O,
between 1 wt % and 10 wt % of Na₂O,
between 60 wt % and 70 wt % SiO₂
between 1 wt % and 10 wt % of B₂O,
between 1 wt % and 10 wt % of ZnO,
below 1 wt % of Sulfur,
below 1 wt % of CaO, and/or
between 1 wt % and 10 wt % of TiO₂.

In a further embodiment, the ultra-thin glass also may include in % by weight on an oxide basis:

| | |
|---|---|
| Al₂O₃ | 10-20 |
| B₂O₃ | 10-20 |
| BaO | 1-10 |
| CaO | 1-10 |
| MgO | 1-10 |
| SiO₂ | 60-70 |
| SnO | <1 |

Particularly suitable ultra-thin glasses for the purpose of the present invention are described in WO 2018/152845 A1, DE 10 2018 116 464 A1, DE 10 2006 016 257 A1 and EP 0 879 800 A1.

The Knoop-Hardness of the ultra-thin glass may have values between 500 and 590, optionally 600 to provide a sufficient hardness in order to support the infrared cut-off filter element in a mechanical manner. Ideally, the Knoop-Hardness of the ultra-thin glass is higher than the Knoop-Hardness of the infrared cut-off filter element, which in particular may be between 360 and 420, in particular between 368 and 418.

In another embodiment, the infrared cut-off filter element includes or consists of at least one of the following glasses, phosphate glass, fluoride phosphate glass, and/or silicate glass. The glasses may contain light absorbing ions, especially copper ions. Those glasses are suitable for applications in camera modules and electronic devices and further provide good optical properties to efficiently block or rather absorb infrared radiation and to transmit wavelengths at least in the visible range.

In the optical system according to the present invention, the at least one NIR blocking filter is optionally an NIR absorbing filter glass, optionally at least one Cu ion doped glass, hereinafter also referred to as blue glass, which optionally has a refractive index nd of at least 1.50. The refractive index nd is known to the skilled person and denotes in particular the refractive index at a wavelength of about 587.6 nm (wavelength of the d-line of helium). In an optional embodiment, the Cu ion-doped glasses according to the present invention are CuO-containing phosphate glasses, the CuO content optionally being in the range from 1 to 20 wt %, optionally from 1-15 wt % and optionally in the range from 2 to 10 wt %, or CuO-containing fluorophosphate glasses, the CuO content optionally being in the range from 0.1 to 10 wt %, optionally in the range from 0.3 to 6.5 wt %. Such CuO-containing glasses are described, for example, in US 2018/0312424 A1, US 2012/0165178 A1, US 2006/0111231 A1, US 2016/0363703 A1, and US 2007/0099787 A1.

In another embodiment, the NIR-absorbing filter glass is a highly refractive Cu ion-doped glass with a refractive index nd of at least 1.70, optionally a CuO-containing glass with a lanthanum borate glass matrix. Such glasses are described, for example, in WO 2020/006770 A1.

To the human eye, the such CuO-containing glasses appear blue, bluish green, turquoise or cyan, in greater thicknesses and at high CuO contents through to black, and can be used as (N)IR cut filters or IR cut-off filters. The colours are inconsequential for many applications. Rather, the filter characteristics in terms of the absorption in the UV to about 300 nm and in the near IR (NIR) at about 850 nm brought about by the addition of the colour-imparting oxide CuO are critical for use as filter, e.g. in front of the sensor of digital cameras. The UV blocking is brought about by the base glass itself and by CuO. In order to keep the UV transmission as high as possible starting from a wavelength of 400 nm (often also 430 nm since shorter wavelengths are no longer visually perceived by human beings), oxidants such as nitrates and/or vanadium oxide (V₂O₅) can be used.

Optionally the IR cut-off filter according to the present invention is a phosphate or fluoro phosphate glass including more than 7 wt %, optionally at least 8 wt %, optionally at least 9 wt % and optionally at least 10 wt % of CuO.

In general, the IR cut-off filter according to the present invention may also have a copper oxide content of more than 9 wt %, optionally more than 10 wt %, optionally more than 10.5 wt % and/or less than 20 wt %, optionally less than 15 wt %, optionally less than 12 wt %.

In an optional embodiment of the present invention the IR cut-off filter consists of or includes a filter glass including the following (in % by weight on an oxide basis, unless indicated otherwise):

| | |
|---|---|
| P₂O₅ | 58-68 |
| Al₂O₃ | 4-10 |
| CuO | 8-15 |
| V₂O₅ | 0-1.5 |
| SiO₂ | 0-2 |
| La₂O₃ | 0-4 |
| F | 0-1 |
| Total R′O (R′ = Mg, Ca, Sr, Ba) | 0-11 |
| Total R2O (R = Li, Na, K) | 3-17 |

The filter glass of the IR cut-off filter may also include or consist of the following composition in % by weight on an oxide basis:

| | |
|---|---|
| P₂O₅ | 60-67 |
| Al₂O₃ | 5-9 |
| CuO | 9-14 |
| V₂O₅ | 0.05-1 |
| SiO₂ | 0-1 |
| La₂O₃ | 0.1-3 |
| F | 0-0.5 |
| Total R′O (R′ = Mg, Ca, Sr, Ba) | 0-8 |
| Total R2O (R = Li, Na, K) | 6-15 |

In another optional embodiment of the present invention, the IR cut-off filter consists of or includes a filter glass including the following (in % by weight on an oxide basis, unless indicated otherwise):

| | |
|---|---|
| P₂O₅ | 60-67 |
| Al₂O₃ | 5-9 |
| CuO | 9-14 |
| V₂O₅ | 0-1.5 |
| SiO₂ | 0-2 |
| La₂O₃ | 0.1-3 |
| F | 0-1 |
| MgO | 1-5 |
| CaO | 0-3 |
| SrO | 0-3 |
| BaO | 0-3 |
| Li₂O | 0-2 |
| Na₂O | 0.5-8 |
| K₂O | 3-10 |

In still another optional embodiment of the present invention, the IR cut-off filter consists of or includes a filter glass including the following (in % by weight on an oxide basis, unless indicated otherwise):

| | |
|---|---|
| P₂O₅ | 61-66 |
| Al₂O₃ | 5-8 |
| CuO | 10-13 |
| V₂O₅ | 0.1-0.75 |
| SiO₂ | 0-1.5 |
| La₂O₃ | 1-3 |
| F | 0-0.5 |
| MgO | 2-4 |
| CaO | 0-1 |
| SrO | 0-1 |
| BaO | 0-1 |
| Li₂O | 0.5-1.5 |
| Na₂O | 2-6 |
| K₂O | 5-9 |

Particularly suitable copper-containing, especially copper oxide containing, filter glasses are described in DE 10 2017 207 253 A1.

A suitable infrared cut-off filter element has to be thin. Since absorption properties may decrease with decreasing thickness the copper oxide content should be high enough to provide sufficient optical properties, especially a high absorption capacity. A high copper oxide content of greater than 10 wt % in combination with a small thickness provides a sufficient absorption for the intended application.

In another aspect of the present invention, the thickness of the infrared cut-off filter element is less than 0.22 mm, optionally less than 0.12 mm, and/or greater than 0.10 mm.

In a further embodiment the thickness of the infrared cut-off filter element is less than 0.22 mm, optionally less than 0.18 mm, optionally less than 0.16 mm, optionally less than 0.14 mm and/or greater than 0.10 mm, optionally greater than 0.11 mm, optionally greater than 0.12 mm. Most optional is a thickness of about 0.11 mm or 0.2 mm. In view of a combination with the first and/or second cover element, those thicknesses are beneficial to match thicknesses of commonly used infrared cut-off filters.

In an alternative embodiment, the infrared cut-off filter element or rather the CuO-containing glass of the infrared cut-off filter element may include a glass containing:
between 1 wt % and 10 wt % of Al₂O₃,
between 1 wt % and 10 wt % of BaO,
between 10 wt % and 20 wt % of CaO,
between 1 wt % and 10 wt % of K₂O,
between 1 wt % and 10 wt % of MgO,
between 1 wt % and 10 wt % of Na₂O,
between 50 wt % and 60 wt % of phosphor oxide (for example P₂O₅ or P₄Oₙ) and/or
between 1 wt % and 7 wt % of Cu₂O.

According to an aspect of the present invention, the ultrathin glass may be a chemically toughened glass or rather the first and/or second cover element may include chemically toughened glass to further improve the mechanical stability and strengthen the infrared cut-off filter arrangement.

In an optional embodiment, at least one layer including an optionally optically clear adhesive is arranged between the infrared cut-off filter element and at least one of the first and/or second cover elements. That way, the infrared cut-off filter element may be bonded to the first and/or second cover element. Other techniques to combine the infrared cut-off filter element to at least one or two cover elements may also be suitable, for example anodic bonding or laser bonding. Since the cover element/s is/are bonded to the infrared cut-off filter element, which optionally includes or consists of CuO-containing glass, the infrared cut-off filter arrangement may be denoted as Bond BG.

A bonding of the infrared cut-off filter element and the cover elements prevents an unwanted movement between these components, for example in case of a shock or vibration of the electronic device. To improve the durability of the infrared cut-off filter arrangement, the optionally optically clear adhesive may include a resin, especially an acrylic or epoxy based resin and/or is strong enough to resist a spring back or peel off of one of the components, which is in contact to the optionally optically clear adhesive.

In a further embodiment a laser or anodic bonded CuO-containing glass also may include a resin to further improve the bonding stability between the cover glass(es) and the infrared cut-off filter.

In a further aspect of the present invention, the thickness of at least one layer of adhesive is less than 0.1 mm, optionally less than 0.03 mm, optionally less than 0.02 mm and/or greater than 0.1 mm, optionally greater than 0.01 mm. In view of a bonded CuO-containing glass or rather infrared cut-off filter arrangement, which includes several components, those thicknesses are beneficial to match thicknesses of commonly used infrared cut-off filters.

In further optional embodiments, the first or the second cover element, has a thickness of between 0.1 mm and 0.18 mm.

The infrared cut-off filter arrangement may include one or two layers of adhesive and, respectively, may include one or two cover elements, wherein the adhesive is optionally positioned between the infrared cut-off filter element and one or each cover element.

In an embodiment, at least one layer of optionally optically clear adhesive is transparent and/or includes ink or pigments. Optionally, two or all of the layers of optionally optically clear adhesive are transparent or include ink and/or pigments. At least one or more layers of optionally optically clear adhesive is/are doped, respectively. Ink or doped layers of adhesive beneficially supply additional absorption at certain wavelengths to the infrared cut-off filter element and/or arrangement, for example in the infrared spectrum.

Transparent adhesive provides a good transmission to wanted wavelengths and ensures the functionality of the infrared cut-off filter arrangement or at least prevents negative absorption, blocking or reflection effects. Depending on specific applications, it may be suitable that the infrared cut-off filter arrangement includes different adhesives, for example, one doped adhesive and one which is transparent or has very high transparency to specific wavelengths, optionally wavelengths of the spectrum of visible light.

According to an aspect of the present invention, the infrared cut-off filter arrangement includes an infrared- and/or an antireflection coating. The coating may provide an additional protection for the sensor and increases the efficiency of blocking IR radiation to prevent an exposure of the sensor with IR radiation. The IR reflecting coating and/or the antireflection coating may include, for example, a multi-layer structure, in particular a multi-layer structure which includes one or more dielectric layers. The dielectric layers may include oxides, nitrides, oxinitrides and/or a mixture of them.

Optionally the infrared- and/or the antireflection coating is deposited on one surface of the at least one cover element, in particular on a surface of the cover element, which faces the lens or the sensor, or rather on a surface that is opposite to this surface, which may face the image sensor.

The term “faces an element” is meant to disclose “arranged in front of that element without further elements, especially optical elements in the beam path to that element. The term faces may also describe one component that is arranged essentially parallel to another component, for example such that a surface of a first component is arranged almost parallel, or in a small angle of between 0° and 10° to a surface of a second component in particular without any further components in between along the optical beam path.

However, the infrared- and/or the antireflection coating is deposited on the second major surface of the infrared cut-off filter element. In another embodiment, the infrared- and/or the antireflection coating is deposited on one side surface of the infrared cut-off filter arrangement or alternatively on two, in particular opposing side surfaces of the infrared cut-off filter arrangement.

A combined use of infrared reflecting and the infrared absorption of the infrared cut-off filter element has the advantageous effect of enabling the use of an improved thin infrared cut-off filter arrangement according to the aforementioned embodiments. The combined use improves the filter characteristics as compared with using only the infrared cut-off filter element, steeper curve (i.e. a steeper infrared cut-off edge in the transmission spectrum of the filter), higher filter attenuation and hence increase the effectivity of the infrared cut-off filter arrangement. Further, negative effects, such as a schlieren effect or a dependence of impurities or surface roughness in CuO-containing glass and/or ultra-thin glass of the infrared cut-off filter element or rather the cover elements may also be decreased.

In an optional embodiment, the total thickness of the infrared cut-off filter arrangement including the thickness of the ultra-thin glass of the second cover element is below 0.35 mm, optionally below 0.3 mm, optionally below 0.25 mm, optionally below 0.22 mm. According to a specific optical design, the total thickness of the infrared cut-off filter arrangement is 0.21 mm±0.02 mm. However, other values such as those larger than 0.35 mm or less than 0.21 mm may be suitable, so that the infrared cut-off filter arrangement may be directly used to replace commonly used infrared cut-off filters, in particular to replace commonly used infrared cut-off filters with a thickness of 0.21 mm. Those thicknesses are especially useful for camera applications in electronic handheld devices, such smartphone cameras or notebooks.

Depending on the intended application, the total thickness of the infrared cut-off filter arrangement is less or smaller than 0.5 mm, optionally smaller than 0.4 mm, optionally smaller than 0.35 mm and/or greater than 0.2 mm, optionally greater than 0.25 mm, which is especially useful for a camera or a camera module for an automotive application. According to a specific optical design, the total thickness of the infrared cut-off filter arrangement is 0.3 mm+0.02 mm.

The present invention also provides an optical sensing arrangement for a camera module, wherein the optical arrangement at least includes:
an optical lens;
an image sensor, especially sensing optical signals within a spectrum of visible light, in particular electromagnetic radiation at wavelengths in the visible range between 380 nm and 750 nm;
an infrared cut-off filter arrangement according to the aforementioned description,
wherein the optical lens and the infrared cut-off filter arrangement are optionally arranged along an incident optical beam path of light propagating towards the image sensor.

Optionally, the components of the optical sensing arrangement are arranged and adjusted such that, the lens is not able to touch or come in contact to the infrared cut-off filter arrangement, for example in case of a shock of the optical sensing arrangement or the camera module. The infrared cut-off filter arrangement may be arranged such that the first major surface and in particular the first cover element is directed or rather faces the image sensor.

Beneficially, the thicknesses of the infrared cut-off filter element, the cover element/s, the adhesive and/or the coating are adjusted such that the total thickness of the infrared cut-off filter arrangement matches at least one commonly used thickness of IRCF, in particular such that the total thickness is below 0.22 mm or 0.21 mm±0.02 mm. That way, the optical sensing arrangement may be applied to common electronic devices. Further, production costs may be reduced, because certain components, such as the lens or the sensor do not need to be customized to this specific optical sensing arrangement.

The present invention also provides a method for producing an infrared cut-off filter arrangement for a camera or a camera module for an optical sensing arrangement for an electronic device, especially a hand held electronic device, optionally for producing an infrared cut-off filter arrangement as described above, wherein the method includes:
providing at least one infrared cut-off filter element, which includes or consists of CuO-containing glass;
providing at least a first cover element, which includes ultra-thin glass
combining the first cover element with the infrared cut-off filter element such that the first cover element is arranged in front of a first major surface of the infrared cut-off filter element, optionally such that the first cover element and the infrared cut-off filter element are optionally arranged along an incident optical beam path of light propagating towards an optical image sensor of the camera or the camera module.

In order to take benefit from the aforementioned advantages, the infrared cut-off filter element, the cover element and/or the infrared cut-off filter arrangement is provided according to the aforementioned description.

To bond the first and/or a second cover with the infrared cut-off filter element, optionally optically clear adhesive may be used. According to an aspect of the present invention, the optionally optically clear adhesive is applied in a liquid form, and in particular, cures after it has been applied to the infrared cut-off filter element and/or to at least one or more cover elements. Optionally, the optionally optically clear adhesive cures by drying or after a curing process has been triggered, for example by ultraviolet radiation or heat.

In an optional embodiment, an infrared- and/or an antireflection coating is provided. The infrared- and/or the antireflection coating may be deposited on one surface of the at least one cover element, in particular on a surface of the cover element, which faces the lens or the sensor, or rather on the surface that is opposite to the surface, which faces the infrared cut-off filter element. Ideally, the deposition takes place after the infrared cut-off filter element and at least one cover element have been bonded. Beneficially, that way, the infrared cut-off filter element and/or the cover element/s may be processed independently of their orientation and thus process costs may be reduced. However, the infrared- and/or an antireflection coating may alternatively be deposited before bonding the infrared cut-off filter element and at least on one cover element.

In an optional embodiment the infrared- and/or the antireflection coating is deposited on the front, i.e. the first and/or in particular on the second major surface of the infrared cut-off filter element. In another embodiment, the infrared- and/or the antireflection coating is deposited on one side surface of the infrared cut-off filter arrangement or alternatively on two, in particular opposing side surfaces of the infrared cut-off filter arrangement.

In a beneficial embodiment, a second cover element, including ultra-thin glass is provided and arranged, such that the infrared cut-off filter element is arranged between the first and second cover element, wherein an optionally optically clear adhesive is included between the infrared cut-off filter element and at least one of the cover elements. That way, the infrared cut-off filter element may be protected at both surfaces, at a first surface, which might be a front surface, and at a second major surface, which might be a rear surface in view of an incident optical beam path of light propagating towards an optical image sensor of the camera or the camera module.

A suitable production sequence of the infrared cut-off filter arrangement may include the following steps:
providing at least one infrared cut-off filter element, which includes or consists of CuO-containing glass;
providing at least a first cover element and optionally also the second cover element;
providing optionally optically clear adhesive;
applying the optionally optically clear adhesive to the infrared cut-off filter element, in particular to the front and/or second major surface of the infrared cut-off filter element;
alternatively or additionally, applying the optionally optically clear adhesive to the first and/or second cover element, in particular to a surface of the first and/or second cover element, which is arranged in front of the infrared cut-off filter element, especially, which is arranged in front of the front or second major surface of the infrared cut-off filter element;
applying the first cover element to the infrared cut-off filter element, in particular to the first major surface of the infrared cut-off filter element;
optionally, applying the second cover element to the infrared cut-off filter element, in particular to the second major surface of the infrared cut-off filter element;
optionally, applying an infrared-reflection coating on at least one surface of the infrared cut-off filter arrangement, in particular on a surface of the first and/or second cover element, or on the second major surface of the infrared cut-off filter element;
optionally, applying an antireflection coating on at least one surface of the infrared cut-off filter arrangement, in particular on a surface of the first and/or second cover element, or on the second major surface of the infrared cut-off filter element.

Optionally, at least one of the group consisting of said at least one infrared cut-off filter element, said at least a first cover element and said second cover element, is prepared as a sheet glass and laser cutting is applied to cut said sheet glass, especially for obtaining the intended lateral dimension.

According to an aspect of the present invention, the infrared- and/or the antireflection coating is applied on the first major surface of the infrared cut-off filter element and/or on a surface of the first and/or second cover element, which faces the infrared cut-off filter element.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1 shows an exploded view of a camera module;

FIG. 2 is a schematic view of a voice coil motor with an optical lens or lens system;

FIG. 3 is a schematic view of a voice coil motor without an optical lens or lens system;

FIG. 4 is a schematic view of a movement of the lens or lens system;

FIG. 5 is a schematic view of an infrared cut-off filter arrangement according to an embodiment including an infrared cut-off filter element and a first cover element;

FIG. 6 is a schematic view of the infrared cut-off filter arrangement according to an embodiment including an infrared cut-off filter element, a first cover element and a second cover element; and

FIG. 7 is a schematic view of the thicknesses of the infrared cut-off filter arrangement, the infrared cut-off filter element, the first cover element and the second cover element.

Corresponding reference characters indicate corresponding parts throughout the several views. The exemplifications set out herein illustrate at least one embodiment of the invention, and such exemplifications are not to be construed as limiting the scope of the invention in any manner.

### DETAILED DESCRIPTION OF THE INVENTION

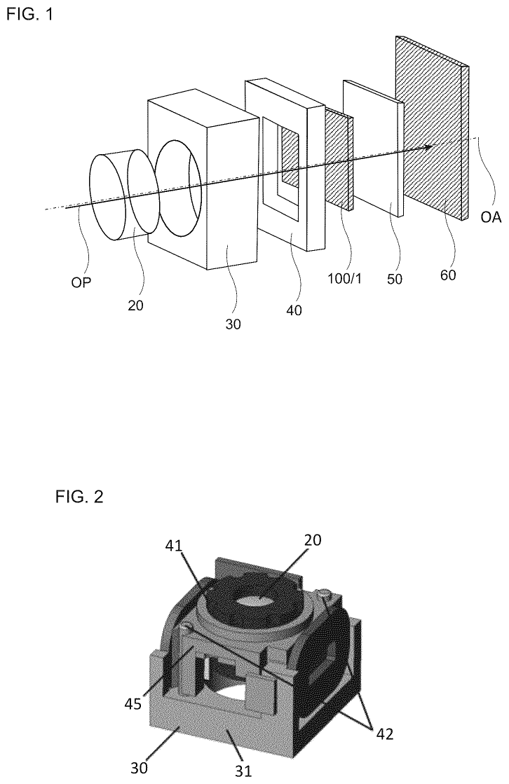

FIG. 1 shows a camera module for electronic devices including a lens 20 or lens system 20, a Voice Coil Motor (VCM) 30, a holder 40, an infrared cut-off filter (IRCF) 100, an optical image sensor 50 and a printed circuit board 60, which are arranged along an incident optical beam path OP of light propagating form the lens 20 towards the optical image sensor 50.

In the context of the disclosure of the present invention, the above mentioned incident optical beam path OP propagating from the lens 20 towards the optical image sensor 50 is chosen to propagate along the optical axis OA or optical symmetry axis of the lens 20 or lens system 20, and especially along the optical axis or optical symmetry axis of the infrared cut-off filter arrangement 1.

According to FIG. 1, besides a lens 20, the optical image sensor 50 and the infrared cut-off filter 100 or rather an infrared cut-off filter arrangement 1, the optical sensing arrangement may also include in a camera a housing for accommodating the respective components of the optical sensing arrangement and, especially the infrared cut-off filter arrangement, which for the sake of clarity is not shown explicitly in the appended drawings.

The lens 20 may be positioned at least partially within the VCM 30 in order to be moved and controlled by the VCM 30, which is fed by electric current.

Optionally, the lens 20 is movable along, especially parallel to the optical symmetry axis OA, i.e. parallel to the optical beam path OP in particular in a direction to the optical image sensor 50.

Holder 40 holds the VCM and/or ensures or rather provides a suitable position for the infrared cut-off filter arrangement 1.

The infrared cut-off filter arrangement 1 is optionally positioned between the lens 20 and the sensor 50, wherein, the holder may be positioned between the VCM 30 and the infrared cut-off filter arrangement 1.

In some optional embodiments, sensor 50 is arranged between the infrared cut-off filter arrangement 1, which protects the sensor 50 from incoming infrared radiation and the printed circuit board 60, which processes the data or signals from the sensor 60.

Sensor 50 is capable to detect incoming electromagnetic radiation, in particular electromagnetic radiation at wavelengths below the infrared spectrum, especially at wavelengths in the visible range between 380 nm und 750 nm.

However, sensor 50 additionally or alternatively may be capable to detect wavelengths below the visible spectrum, in particular below 380 nm and/or in the ultraviolet spectrum.

The optical sensing arrangement includes an infrared cut-off filter arrangement 1, which is disclosed in FIG. 4, 5, 6, or 7.

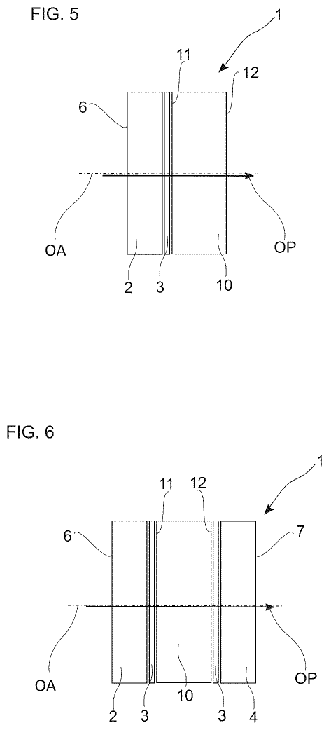

According to FIG. 5, the infrared cut-off filter arrangement 1 includes at least one infrared cut-off filter element 10, a first cover element 2 and/or an optical clear adhesive.

Optionally, the optical clear adhesive is arranged between the first cover element 2 and the infrared cut-off filter element 10, and in particular bonds or combines the first cover element 2 and the infrared cut-off filter element 10 in order to provide a strong bonded infrared cut-off filter arrangement 1.

The infrared cut-off filter element 10 includes or is made of CuO-containing glass, which optionally besides other components includes:

Optionally the IR cut-off filter according to the present invention is a phosphate or fluoro phosphate glass including more than 7 wt %, optionally at least 8 wt %, optionally at least 9 wt % and optionally at least 10 wt % of CuO.

In general, the IR cut-off filter according to the present invention may also have a copper oxide content of more than 9 wt %, optionally more than 10 wt %, optionally more than 10.5 wt % and/or less than 20 wt %, optionally less than 15 wt %, optionally less than 12 wt %.

In an optional embodiment of the present invention the IR cut-off filter consists of or includes a filter glass including the following (in % by weight on an oxide basis, unless indicated otherwise):

| | |
|---|---|
| P₂O₅ | 58-68 |
| Al₂O₃ | 4-10 |
| CuO | 8-15 |
| V₂O₅ | 0-1.5 |
| SiO₂ | 0-2 |
| La₂O₃ | 0-4 |
| F | 0-1 |
| Total R′O (R′ = Mg, Ca, Sr, Ba) | 0-11 |
| Total R2O (R = Li, Na, K) | 3-17 |

The filter glass of the IR cut-off filter also may also include or consist of the following composition in % by weight on an oxide basis:

| | |
|---|---|
| P₂O₅ | 60-67 |
| Al₂O₃ | 5-9 |
| CuO | 9-14 |
| V₂O₅ | 0.05-1 |
| SiO₂ | 0-1 |
| La₂O₃ | 0.1-3 |
| F | 0-0.5 |
| Total R′O (R′ = Mg, Ca, Sr, Ba) | 0-8 |
| Total R2O (R = Li, Na, K) | 6-15 |

In another optional embodiment of the present invention the IR cut-off filter consists of or includes a filter glass including the following (in % by weight on an oxide basis, unless indicated otherwise):

| | |
|---|---|
| P₂O₅ | 60-67 |
| Al₂O₃ | 5-9 |
| CuO | 9-14 |
| V₂O₅ | 0-1.5 |
| SiO₂ | 0-2 |
| La₂O₃ | 0.1-3 |
| F | 0-1 |
| MgO | 1-5 |
| CaO | 0-3 |
| SrO | 0-3 |
| BaO | 0-3 |
| Li₂O | 0-2 |
| Na₂O | 0.5-8 |
| K₂O | 3-10 |

In a still another optional embodiment of the present invention, the IR cut-off filter consists of or includes a filter glass including the following (in % by weight on an oxide basis, unless indicated otherwise):

| | |
|---|---|
| P₂O₅ | 61-66 |
| Al₂O₃ | 5-8 |
| CuO | 10-13 |
| V₂O₅ | 0.1-0.75 |
| SiO₂ | 0-1.5 |
| La₂O₃ | 1-3 |
| F | 0-0.5 |
| MgO | 2-4 |
| CaO | 0-1 |
| SrO | 0-1 |
| BaO | 0-1 |
| Li₂O | 0.5-1.5 |
| Na₂O | 2-6 |
| K₂O | 5-9 |

The infrared cut-off filter element 10 may further be provided as a sheet-shaped or sheet-like CuO-containing glass element, in particular with a front 11 and an opposing rear 12 surface.

Optionally, the front or first major surface 11 is directed to the lens 20, especially against the optical beam path OP. However, the first major surface 11 may alternatively be directed to the optical image sensor 50.

In some embodiments, the first major surface 11 and a surface of the first cover element 2 is covered with the optical clear adhesive 3. The other surface of the first cover element 2 optionally forms a surface or side surface 6 of the infrared cut-off filter arrangement 1, which is directed to the lens 20.

The first cover element 2 includes or is made of ultra-thin glass, having optionally a thickness smaller than 0.3 mm, and/or greater than 0.05 mm, optionally greater than 0.07 mm.

In a further embodiment the thickness of the ultra-thin glass is optionally between 0.1 mm and greater than 0.001 mm, in particular between 0.1 mm and 0.01 mm.

To provide an increased mechanical strength to the infrared cut-off filter arrangement 1 and/or a sufficient transparency, in particular to light in the visible range according to the aforementioned wavelengths, the first cover element 2 or rather the ultra-thin glass includes or is made of alumosilicate glass, lithium alumosilicate glass, sodalime glass and/or boroslicate glass.

The ultra-thin glass may includes or is made of glass, which, in particular besides other components in particular contains:
between 10 wt % and 20 wt % of Al₂O₃,
between 1 wt % and 10 wt % of K₂O,
between 10 wt % and 20 wt % of Na₂O,
between 60 wt % and 70 wt % SiO₂
between 1 wt % and 10 wt % of MgO,
below 1 wt % of SnO,
below 1 wt % of AlF₃,
between 1 wt % and 10 wt % of ZrO₂ and/or
   alternatively, the ultra-thin glass may include:
between 1 wt % and 10 wt % of Al₂O₃,
between 1 wt % and 10 wt % of K₂O,
between 1 wt % and 10 wt % of Na₂O,
between 60 wt % and 70 wt % SiO₂
between 1 wt % and 10 wt % of B₂O,
between 1 wt % and 10 wt % of ZnO,
below 1 wt % of Sulfur,
below 1 wt % of CaO, and/or
between 1 wt % and 10 wt % of TiO₂.

These glasses are optionally used to provide an improved mechanical strength to the infrared cut-off filter arrangement 1.

In accordance with a statistical Weibull distribution, the strength of the infrared cut-off filter arrangement 1 has been determined by performing a common and standardized ball drop test according to or similar to ASTM F 3007 as well a ring on ring test according or similar to ASTM C1499, wherein specimens were placed on a support ring (12 mm in diameter) and a force acted on a smaller load ring with 6 mm in diameter, which induces tensile stress at the bottom of the specimen. Within the load ring area the stress is constant and isotropic, wherein it drops quickly towards outside and the edge of the ring.

The ring-on-ring tests revealed that the infrared cut-off filter arrangement 1 according to embodiments of the present invention withstands a B10 mechanical stress of more than 10 N, in some embodiments of more than 12 N, in further embodiments of more than 16 N and in optional embodiments of more than 19 N. While current widely used infrared cut-off filter have the same 0.21 mm thickness, these only had a B10 mechanical stress around 3N.

The ball drop test revealed that the infrared cut-off filter arrangement 1 withstands a ball drop from a ball having about 5 g in weight falling on the infrared cut-off filter arrangement 1 from a B10 height of more than 45 mm. Some embodiments withstand a height of more than 50 mm, optional embodiments of more than 60 mm, and optional embodiments of more than 65 mm, without any damage to the infrared cut-off filter arrangement 1. Currently widely used infrared cut-off filters having the same 0.21 mm thickness only have a B10 breakage height around 35 mm.

Optionally, an infrared- and/or an antireflection coating is deposited at least on the second major surface 12 of the infrared cut-off filter element 10 and/or on the surface 6 of the infrared cut-off filter arrangement 1, which is directed to the lens 20 and which is also termed sides surface 6.

In an optional embodiment, the infrared-reflection coating is deposited on the second major surface 12 of the infrared cut-off element 10 and the antireflection coating is deposited on the surface 6 of the infrared cut-off filter arrangement 1, which is directed to the lens 20, or vice versa.

Significantly, the infrared reflecting coating and/or the antireflection coating may include a multi-layer structure, in particular a multi-layer structure which includes one or more dielectric layers. The dielectric layers may include oxides, nitrides, oxinitrides and/or a mixture of them.

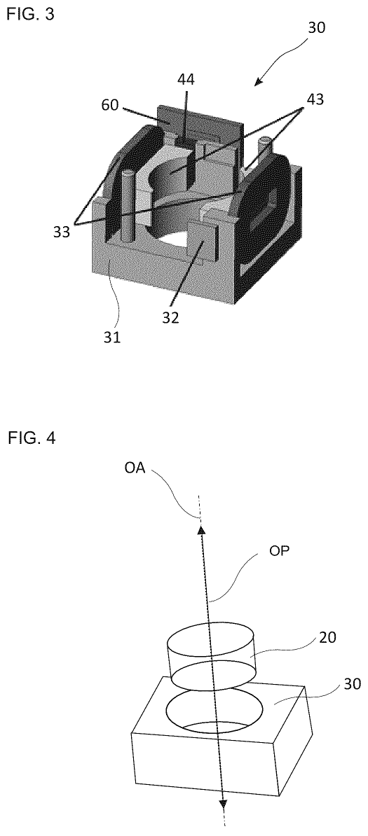

In FIGS. 2 and 3, a voice coil motor (VCM) 30 is depicted. The VCM 30 at least includes a base 31, a mount 41 for holding the lens 20 or the lens system, a bracket 45 for holding the mount 41, optionally for holding the mount 41 or rather the lens 20 or lens system in a movable position within the VCM 30, and at least one, optionally two or more, guide rods 42 for guiding the bracket 45.

FIG. 2 shows the VCM 30 with an optical lens 20 or lens system 20, which is configured to be movable by at least one actuator, optionally by more than one, for example two or more actuators.

FIG. 3 shows the VCM 30 of FIG. 2 in more detail, without the lens 20.

Electronic and/or magnetic components 32, 33, 43, 44, 60 are arranged at the base 31 of the VCM 30. A printed circuit board 60 and/or a magnetoconductive plate 32 are configured to control the VCM or rather a movement of the lens 20 or lens system.

In order to enable a movement of the lens 20 or lens system 20 and to provide an autofocus functionality, actuators, optionally in the form of coils 33, are arranged at sidewalls of the base 31.

In general, the VCM includes magnets, optionally permanent magnets, and a supporting hall element 44 for controlling the movement of the lens 20 or lens system caused by the respective current carrying coils.

The movement or motion of the lens 20 or lens system 20 is shown in FIG. 4.

The lens 20 or lens system 20 includes an optical symmetry axis OA along or rather parallel to the optical beam path (OP).

Guide rods 42 may support such movement and keep the lens 20 or lens system 20 in line parallel to the optical symmetry axis OA.

According to FIG. 6, the infrared cut-off filter arrangement 1 shown in FIG. 5 includes in addition a second cover element 4 and/or a further layer of optical clear adhesive 3, in particular such that the infrared cut-off filter element 10 is sandwiched between the first 2 and second 4 cover elements, wherein optionally the further layer of optical clear adhesive is arranged between the infrared cut-off filter element 10 and the second cover element 4.

A surface of the second cover element 4, which faces the infrared cut-off filter element 10, is bonded, for example by the optical clear adhesive to the second major surface 12 of the infrared cut-off filter element 10. In sequence, and along the optical beam path OP or the optical symmetry axis OA, in this embodiment the infrared cut-off filter arrangement 1 optionally includes the first cover element 2, one layer of optical clear adhesive, the infrared cut-off filter element 10, and optionally one layer of optical clear adhesive 3 and the second cover element 4.

At least one layer, especially both or all layers of optionally optically clear adhesive are transparent and/or may include ink and/or pigments. Depending on specific applications, one layer of optical clear adhesive may be transparent, while another layer includes ink and/or pigments.

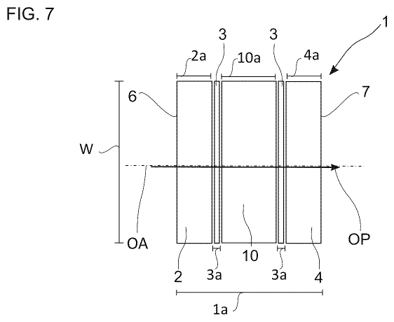

As shown in FIG. 7, like the first cover element 2, the second cover element 4 includes or is made of ultra-thin glass, wherein the thickness 2a of the ultra-thin glass, in particular the thickness 2a of the first cover element 2 and/or the thickness 4a of the second cover element 4 is optionally smaller than 0.3 mm, and/or greater than 0.05 mm, optionally greater than 0.07 mm.

In a further embodiment, the thickness 2a of the first cover element 2 and/or the thickness 4a of the second cover element 4 is between 0.1 mm and greater than 0 mm, in particular between 0.1 mm and 0.001 mm.

Optionally, an infrared- and/or an antireflection coating is deposited in some embodiments also on surface or side surface 7 of the infrared cut-off filter arrangement 1, which is directed to the sensor 50.

In general, the total thickness 1a of the infrared cut-off filter arrangement 1 is below 0.35 mm, optionally below 0.3 mm, optionally below 0.25 mm, optionally below 0.22 mm.

According to a specific optical designs, the total thickness 1a of the infrared cut-off filter arrangement may be 0.21 mm+0.02 mm.

In order to match or reduce the total thickness 1a of the infrared cut-off filter arrangement 1, the thickness 10a of the infrared cut-off filter element 10 is in some embodiments optionally between 0.22 mm, optionally 0.2 mm and 0.10 mm. Optional is a thickness of about 0.11 mm.

Further, the thickness of the ultra-thin glass 2a, 4a of the first 2 and/or second 4 cover element is in some embodiments between 0.1 mm and greater than 0 mm, in particular smaller than 0.1 mm, optionally smaller than 0.01 mm. Optionally, at least one cover element 2, 3, in particular the first cover element 2 has a thickness of between 0.03 and 0.07 mm. Optionally, the thickness 2a, 4a of one cover element 2, 4, in particular the second cover element 4 may be between 0.1 mm and greater than 0 mm, optionally smaller than 0.01 mm and greater than 0.001 mm.

Accordingly, the thickness 3a of at least one layer of adhesive is between greater than 0.001 mm and 0.1 mm, optionally 0.03 mm. The thickness 3a of one layer of optical clear adhesive may be larger or smaller than the thickness 3a of another layer of optical clear adhesive.

Of course, the above mentioned thicknesses shown in FIG. 7 may also be realized in the embodiments shown in FIGS. 4 and 5.

The thicknesses 1a, 2a, 3a, 10a are typically to be understood as perpendicular to a width W of a respective component 2, 3, 4, 10 and/or of the infrared cut-off filter arrangement 1, wherein optionally the width W extends perpendicular to a length (not shown) of the respective component 2, 3, 4, 10 and/or of the infrared cut-off filter arrangement 1. Accordingly, the thickness may be defined along a surface normal of the first 11 or second 12 surface of the infrared cut-off filter element 10 or of surface 6 in the direction to the lens 20 or of the surface 7, which is directed to the sensor 50. The thicknesses 1a, 2a, 3a of each component 2, 3, 4, 10a may beneficially be smaller than the width W and/or length of the respective component 2, 3, 4, 10 for example of the first 2 and/or second 4 cover element, the layer of optical adhesive 3 and/or the infrared cut-off filter element 10.

From the foregoing description, a person skilled in the art may easily adopt the essential characteristics of the disclosed invention and, without departing from the spirit and scope thereof, can make various changes and modifications to adapt the invention to various further uses and conditions.

List of reference symbols:

| | |
|---|---|
| 1 | infrared cut-off filter arrangement |
| 1a | total thickness of the infrared cut-off filter arrangement |
| 2 | first cover element |
| 2a | thickness of the first cover element |
| 3 | layer of optical adhesive |
| 3a | thickness of the layer of optical adhesive |
| 4 | second cover element |
| 4a | thickness of the second cover element |
| 6 | surface or side surface in a direction towards lens or lens system 20 |
| 10 | infrared cut-off filter element |
| 11 | first major surface |
| 12 | second major surface |
| 20 | lens or lens system |
| 30 | voice coil motor |
| 31 | base |
| 32 | magnetoconductive plate |
| 33 | coils |
| 40 | holder |
| 41 | mount |
| 42 | guide rods |
| 43 | magnets |
| 44 | hall element |
| 45 | bracket |
| 50 | sensor |
| 60 | printed circuit board |
| 100 | infrared cut-off filter, IRCF |
| W | width of the infrared cut-off filter |
| OA | optical axis or optical symmetry axis, especially of lens or |
| | lens system and/or infrared cut-off filter arrangement |
| OP | optical beam path |

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. An optical sensing arrangement for a camera or a camera module for at least one of an automotive application and an electronic device, the optical sensing arrangement comprising:
an optical lens or a lens system;
a sensor; and
an infrared cut-off filter arrangement, which has a total thickness of less than 0.8 mm and which includes:
at least one infrared cut-off filter element, which includes a first major surface and which includes or consists of a glass which includes copper oxide; and
a first cover element, which is arranged in front of the first major surface of the at least one infrared cut-off filter element and which includes an ultra-thin glass.

2. The optical sensing arrangement according to claim 1, wherein the at least one infrared cut-off filter element includes or consists of the glass which has a copper oxide content of more than 9 wt %.

3. The optical sensing arrangement according to claim 1, wherein the infrared cut-off filter arrangement includes a second cover element, which is arranged in an optical beam path.

4. The optical sensing arrangement according to 3, wherein at least one of:
(a) a thickness of the ultra-thin glass of the first cover element is at least one of less than 0.3 mm and greater than 0.05 mm; and
(b) the second cover element includes an ultra-thin glass, a thickness of the ultra-thin glass of the second cover element being at least one of less than 0.3 mm and greater than 0.05 mm.

5. An infrared cut-off filter arrangement for an optical sensing arrangement for a camera or a camera module for at least one of an automotive application and an electronic device, wherein the infrared cut-off filter arrangement comprises:
at least one infrared cut-off filter element, which includes a first major surface and which includes or consists of a glass which includes copper oxide; and
a first cover element, which is arranged in front of the first major surface of the at least one infrared cut-off filter element and which includes an ultra-thin glass, the infrared cut-off filter arrangement having a total thickness of less than 0.8 mm and being configured for the optical sensing arrangement which includes (i) an optical lens or a lens system and (ii) a sensor.

6. The infrared cut-off filter arrangement according to claim 5, wherein the at least one infrared cut-off filter element includes or consists of the glass which has a copper oxide content of more than 9 wt %.

7. The infrared cut-off filter arrangement according to claim 5, wherein the infrared cut-off filter arrangement includes a second cover element, which is arranged in an optical beam path.

8. The infrared cut-off filter arrangement according to claim 7, wherein at least one of:
(a) a thickness of the ultra-thin glass of the first cover element is at least one of less than 0.3 mm and greater than 0.05 mm; and
(b) the second cover element includes an ultra-thin glass, a thickness of the ultra-thin glass of the second cover element being at least one of less than 0.3 mm and greater than 0.05 mm.

9. The infrared cut-off filter arrangement according to claim 7, wherein at least one of the first cover element and the second cover element includes or consists of at least one of the following: alumosilicate glass; lithium alumosilicate glass; sodalime glass; and boroslicate glass.

10. The infrared cut-off filter arrangement according to claim 5, wherein the at least one infrared cut-off filter element includes or consists of at least one of the following: phosphate glass; fluoride phosphate glass; and silicate glass.

11. The infrared cut-off filter arrangement according to claim 5, wherein a thickness of the at least one infrared cut-off filter element is less than 0.22 mm.

12. The infrared cut-off filter arrangement according to claim 5, wherein the infrared cut-off filter arrangement includes a second cover element, wherein the infrared cut-off filter arrangement includes at least one layer including an adhesive, the at least one layer including the adhesive being arranged between the at least one infrared cut-off filter element and at least one of the first cover element and the second cover element.

13. The infrared cut-off filter arrangement according to claim 12, wherein a thickness of the at least one layer including the adhesive is less than 0.1 mm.

14. The infrared cut-off filter arrangement according to claim 12, wherein the at least one layer including the adhesive is at least one of (a) transparent and (b) includes at least one of (i) ink and (ii) a plurality of pigments.

15. The infrared cut-off filter arrangement according to claim 5, wherein the infrared cut-off filter arrangement includes at least one of an infrared coating and an antireflection coating, wherein at least one of:
(a) the at least one infrared cut-off filter element includes a front, and at least one of the infrared coating and the antireflection coating is deposited on the front of the at least one infrared cut-off filter element;
(b) the at least one infrared cut-off filter element includes a second major surface, and at least one of the infrared coating and the antireflection coating is deposited on the second major surface of the at least one infrared cut-off filter element.

16. The infrared cut-off filter arrangement according to claim 5, wherein the infrared cut-off filter arrangement includes a second cover element which includes an ultra-thin glass, the total thickness of the infrared cut-off filter arrangement including a thickness of the ultra-thin glass of the second cover element, the thickness of the ultra-thin glass of the second cover element being below 0.35 mm.

17. The infrared cut-off filter arrangement according to claim 5, wherein the total thickness of the infrared cut-off filter arrangement is less than 0.5 mm.

18. A method for producing an infrared cut-off filter arrangement for an optical sensing arrangement for a camera or a camera module for at least one of an automotive application and an electronic device, the method comprising the steps of:
providing at least one infrared cut-off filter element at a first cover element, the at least one infrared cut-off filter element including or consisting of a glass including copper oxide, the first cover element including an ultra-thin glass; and
combining the first cover element with the at least one infrared cut-off filter element such that the first cover element is arranged in front of a first major surface of the at least one infrared cut-off filter element.

19. The method according to claim 18, wherein the method further includes providing a second cover element which includes an ultra-thin glass, the at least one infrared cut-off filter element being arranged between the first cover element and the second cover element, an adhesive being positioned between the at least one infrared cut-off filter element and at least one of the first cover element and the second cover element.

20. The method according to claim 19, wherein at least one of the group consisting of the at least one infrared cut-off filter element, the first cover element, and the second cover element is prepared as a sheet glass, and laser cutting is applied to cut the sheet glass.
